(19) United States
(12) Patent Application Publication
(10) Pub. No.: US 2025/0050436 A1
(43) Pub. Date: Feb. 13, 2025

(54) MITER SAW WITH MULTIPLE MOTORS

(71) Applicant: Black & Decker Inc., New Britain, CT (US)

(72) Inventors: Austin L. Ganzermiller, Reisterstown, MD (US); Daniel L. Schwarz, Jarrettsville, MD (US)

(21) Appl. No.: 18/932,312

(22) Filed: Oct. 30, 2024

Related U.S. Application Data
(63) Continuation-in-part of application No. 18/647,665, filed on Apr. 26, 2024.
(60) Provisional application No. 63/498,443, filed on Apr. 26, 2023.

(51) Int. Cl. B23D 45/04; B23D 47/02; B23D 47/12

(52) U.S. Cl. CPC B23D 45/044; B23D 47/025; B23D 47/12

(57) ABSTRACT

A miter saw may include a base assembly. A miter saw may include a rotatable table rotatably connected to the base assembly. A miter saw may include a pivot arm pivotally attached to the rotatable table. A miter saw may include a saw assembly supported by the pivot arm, where the saw assembly may include: a drive unit having a plurality of electric motors, a transmission coupled to the drive unit through a master gear, and a blade that is rotatably driven by the drive unit and the transmission.

### CROSS-REFERENCE TO RELATED APPLICATIONS

This application is a continuation-in-part application of U.S. application Ser. No. 18/647,665, filed Apr. 26, 2024, and titled “Multi-Motor Drive System,” which claims priority to and the benefit of U.S. Provisional Application No. 63/498,443, filed Apr. 26, 2023, and titled “Multi-Motor Drive System,” both of which are incorporated herein by reference in their entireties.

### TECHNICAL FIELD

This description relates to a miter saw having multiple motors.

### BACKGROUND

A saw may be used to cut numerous different types of workpieces including wood, metal, composite, plastic, laminate, and the like. In general, a saw includes a motor that generates a driving force, for example, a rotary force or torque, that is transmitted to a blade, causing the blade to rotate and perform a cutting operation on a workpiece.

### SUMMARY

In some aspects, the techniques described herein relate to a miter saw including: a base assembly; a rotatable table rotatably connected to the base assembly; a pivot arm pivotally attached to the rotatable table; and a saw assembly supported by the pivot arm, wherein the saw assembly includes: a drive unit having a plurality of electric motors, a transmission coupled to the drive unit through a master gear, and a blade that is rotatably driven by the drive unit and the transmission.

In some aspects, the techniques described herein relate to a miter saw, wherein the pivot arm includes a handle having a trigger, and the miter saw further includes: a motor control module disposed within the handle.

In some aspects, the techniques described herein relate to a miter saw, wherein the pivot arm includes a battery receptacle for receiving a battery pack, and the miter saw further includes: a blade housing disposed at least partially around the blade, wherein a profile of the blade housing is aligned within a profile of the drive unit.

In some aspects, the techniques described herein relate to a miter saw, wherein a start of rotation of the blade is less than one second from a time when a user initiates operation of the miter saw.

In some aspects, the techniques described herein relate to a miter saw, wherein a rotation of rotors within the plurality of electric motors is in a direction opposite a rotation of the blade.

In some aspects, the techniques described herein relate to a miter saw, further including: a pulley assembly that couples to and receives rotational force from the transmission and imparts rotational force to the blade; and a toothed belt disposed around the pulley assembly to impart the rotational force to the blade.

In some aspects, the techniques described herein relate to a miter saw, wherein a center of gravity of the miter saw is coplanar with the blade.

In some aspects, the techniques described herein relate to a miter saw, wherein the pivot arm includes first and second sliding rails connected to the saw assembly, wherein a plane including the blade is equidistant with the first and second sliding rails.

In some aspects, the techniques described herein relate to a miter saw, wherein a center of gravity of the miter saw is centered about the pivot arm.

In some aspects, the techniques described herein relate to a miter saw, wherein the plurality of electric motors includes a first motor and a second motor, wherein a first motor pinion and a second motor pinion are coupled to the master gear.

In some aspects, the techniques described herein relate to a miter saw, further including a blade housing covering the blade, the blade housing having a first width, and the drive unit having a second width, wherein the second width is equal to or smaller than the first width.

In some aspects, the techniques described herein relate to a miter saw including: a base assembly; a rotatable table rotatably connected to the base assembly; a pivot arm pivotally attached to the rotatable table; and a saw assembly supported by the pivot arm, wherein the saw assembly includes: a drive unit having a first electric motor and a second electric motor, a transmission coupled to the drive unit through a master gear, and a blade that is rotatably driven by the drive unit and the transmission, wherein a center of gravity of the miter saw is coplanar with the blade and centered about the pivot arm.

In some aspects, the techniques described herein relate to a miter saw wherein the pivot arm includes a handle having a trigger, and the miter saw further includes: a motor control module disposed within the handle.

In some aspects, the techniques described herein relate to a miter saw, wherein the pivot arm includes a battery receptacle for receiving a battery pack, and the miter saw further includes: a blade housing disposed at least partially around the blade, wherein a profile of the blade housing is aligned within a profile of the drive unit.

In some aspects, the techniques described herein relate to a miter saw, wherein a start of rotation of the blade is less than one second from a time when a user initiates operation of the miter saw.

In some aspects, the techniques described herein relate to a miter saw, wherein a rotation of a first motor rotor and a second motor rotor within the drive unit is in a direction opposite a rotation of the blade.

In some aspects, the techniques described herein relate to a miter saw, further including: a pulley assembly that couples to and receives rotational force from the transmission and imparts rotational force to the blade; and a toothed belt disposed around the pulley assembly to impart the rotational force to the blade.

In some aspects, the techniques described herein relate to a miter saw, wherein the pivot arm includes first and second sliding rails connected to the saw assembly, wherein a plane including the blade is equidistant with the first and second sliding rails.

In some aspects, the techniques described herein relate to a miter saw, further including a blade housing covering the blade, the blade housing having a first width, and the drive unit having a second width, wherein the second width is equal to or smaller than the first width.

The details of one or more implementations are set forth in the accompanying drawings and the description below. Other features will be apparent from the description and drawings, and from the claims.

### BRIEF DESCRIPTION OF THE DRAWINGS

FIG. 1 depicts a front, left perspective view of an example miter saw.

FIG. 2 depicts a rear, right perspective view of the miter saw of FIG. 1 with some components exposed.

FIG. 3 depicts a front, right perspective view of the miter saw of FIG. 1.

FIG. 4 depicts a front, right perspective cross-section view of the miter saw of FIG. 1.

FIG. 5 depicts a rear, left perspective detail view of the battery interface positioning of the miter saw of FIG. 1.

FIG. 6 depicts a rear, left perspective detail view of the handle of the miter saw of FIG. 1.

FIG. 7 depicts a rear, left perspective detail view of the handle of the miter saw of FIG. 6 with a top cover of the handle removed.

FIG. 8 depicts a perspective view of the multi-motor drive unit of the miter saw of FIG. 1 as disposed on the blade housing.

FIG. 9 depicts a perspective view of the multi-motor drive unit and the transmission of the miter saw of FIG. 1.

FIG. 10 depicts a perspective view of the multi-motor drive unit and the transmission of the miter saw of FIG. 1 with the master pulley attached to the master gear.

FIG. 11 depicts a partial cross-sectional view WW centered on the master pulley of the miter saw of FIG. 1 with the cross-section WW represented in FIG. 10.

FIG. 12 depicts a perspective view of the pulley assembly of the miter saw of FIG. 1.

### DETAILED DESCRIPTION

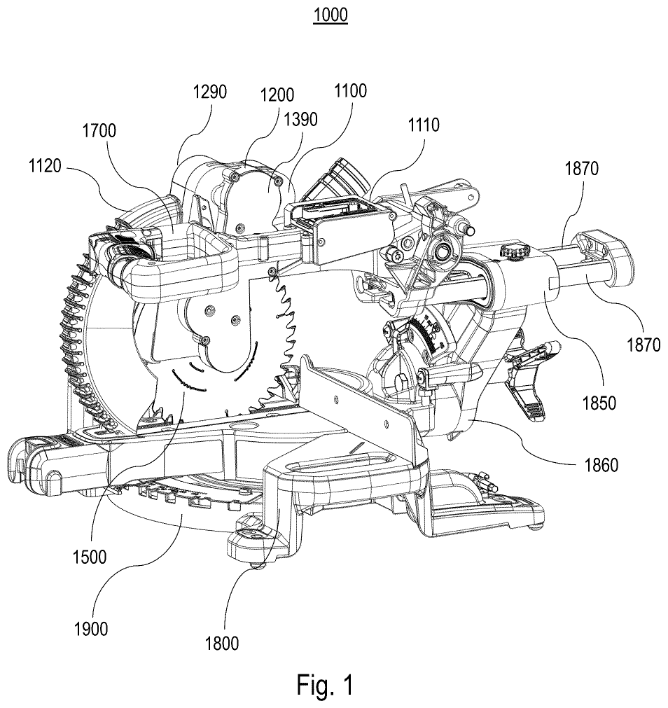

FIGS. 1-12 illustrate an example power tool system, in the form a miter saw 1000. The miter saw 1000 may be used to cut numerous different types of workpieces including wood, metal, masonry, composite, plastic, and the like. The miter saw 1000 may be used for making different types of cuts including, but not limited to, angled cuts, crosscuts, and bevel cuts. The miter saw 1000 may tilt left and right allowing for bevel cuts at various angles.

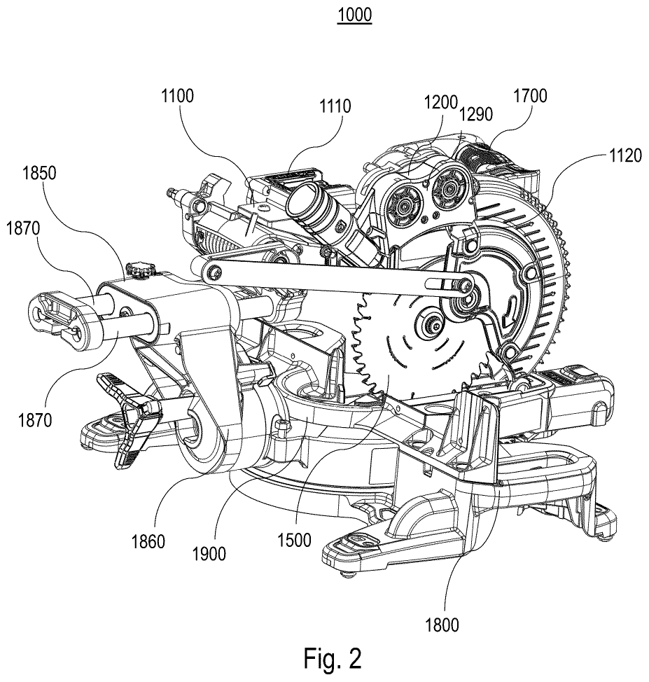

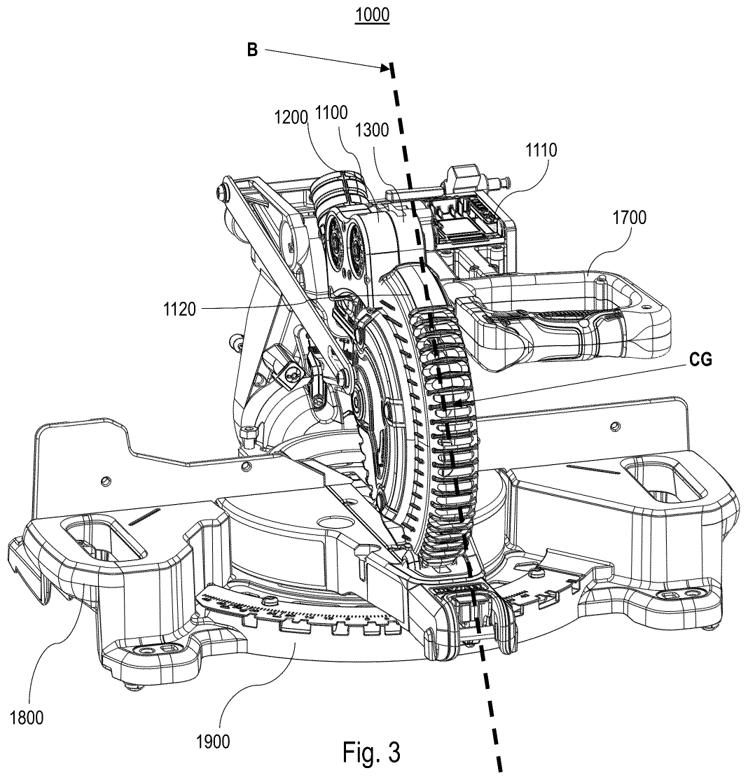

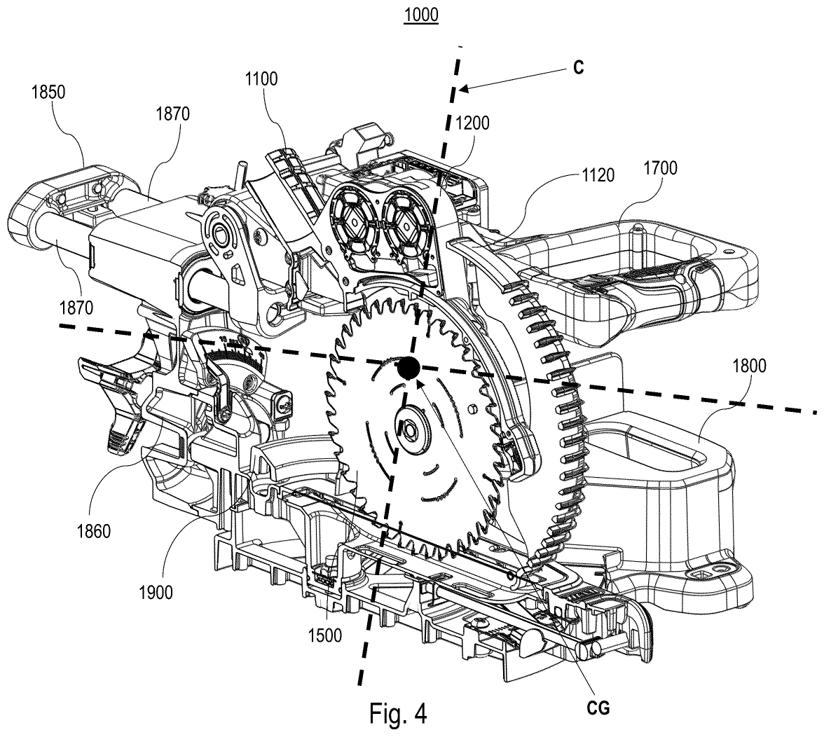

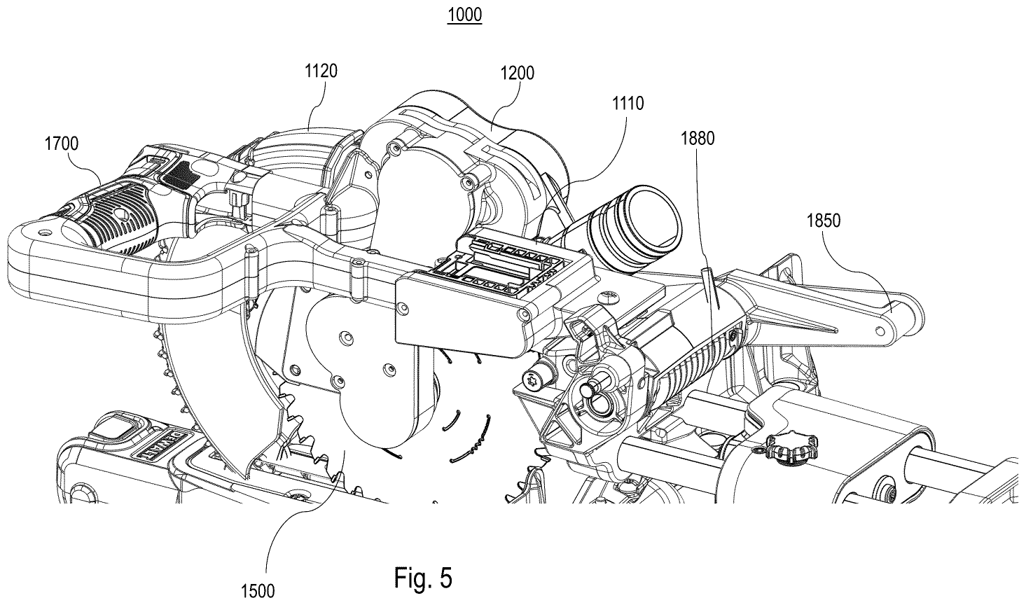

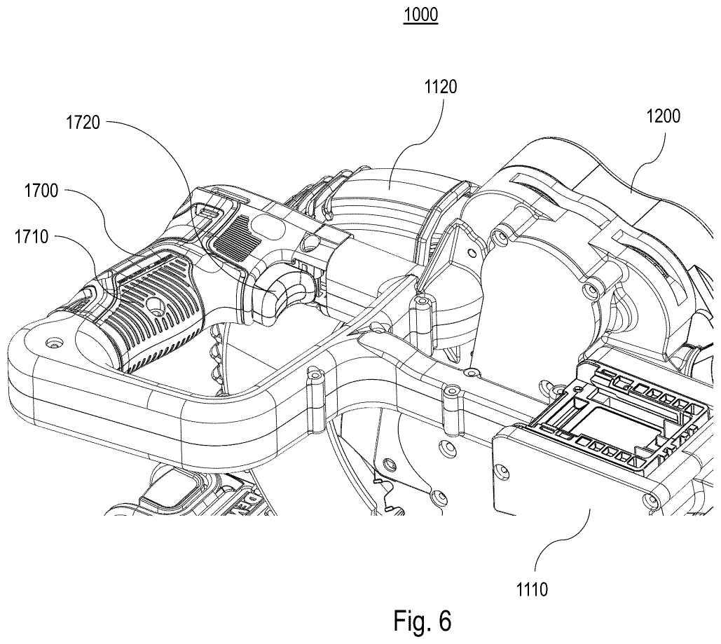

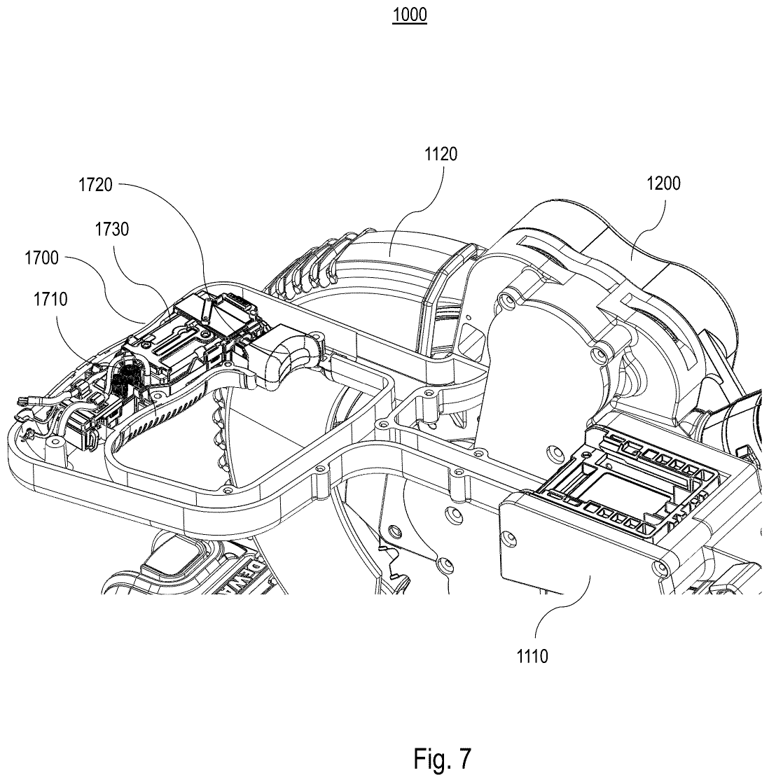

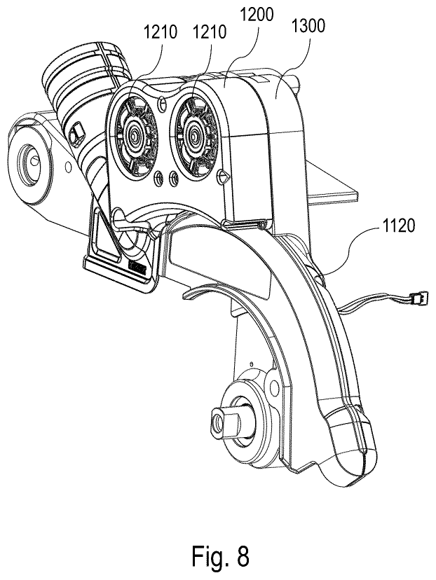

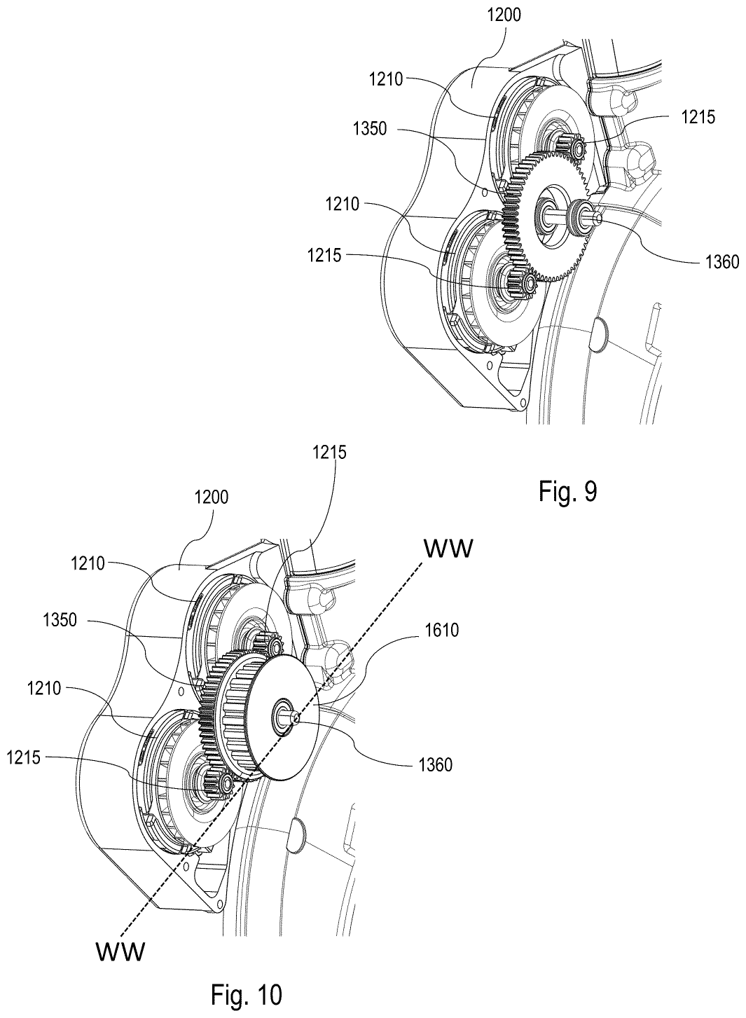

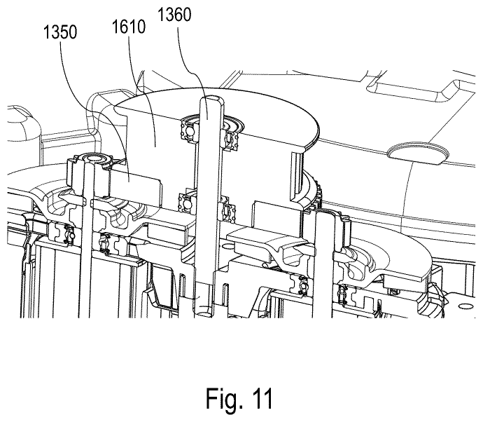

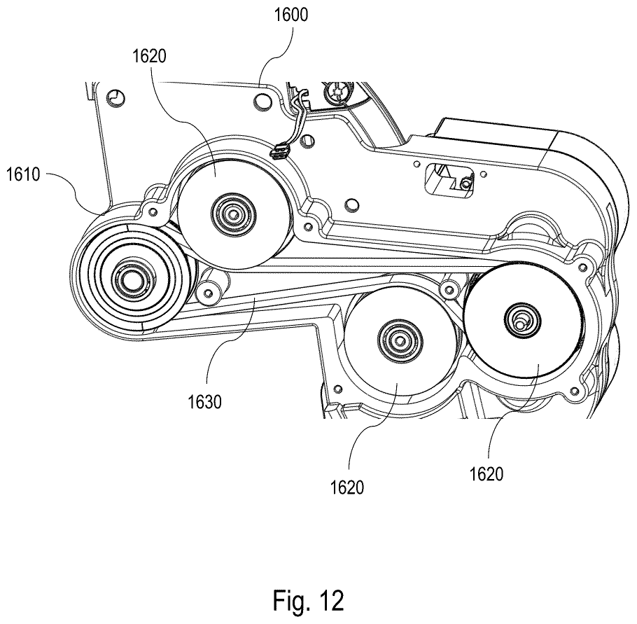

FIG. 1 depicts a front, left perspective view of the miter saw 1000. FIG. 2 depicts a rear, right perspective view of the miter saw 1000 of FIG. 1 with some components exposed. FIG. 3 depicts a front, right perspective view of the miter saw 1000 of FIG. 1. FIG. 4 depicts a front, right perspective cross-section view of the miter saw 1000 of FIG. 1. FIG. 5 depicts a rear, left perspective detail view of the battery interface positioning of the miter saw of FIG. 1. FIG. 6 depicts a rear, left perspective detail view of the handle of the miter saw 1000 of FIG. 1. FIG. 7 depicts a rear, left perspective detail view of the handle of the miter saw 1000 of FIG. 6 with a top cover of the handle removed. FIG. 8 depicts a perspective view of the multi-motor drive unit of the miter saw 1000 of FIG. 1 as disposed on the blade housing. FIG. 9 depicts a perspective view of the multi-motor drive unit and the transmission of the miter saw 1000 of FIG. 1. FIG. 10 depicts a perspective view of the multi-motor drive unit and the transmission of the miter saw 1000 of FIG. 1 with the master pulley attached to the master gear. FIG. 11 depicts a partial cross-sectional view WW centered on the master pulley of the miter saw 1000 of FIG. 1 with the cross-section WW represented in FIG. 10. FIG. 12 depicts a perspective view of the pulley assembly of the miter saw 1000 of FIG. 1.

U.S. Pat. Nos. 7,252,027 and 9,707,633 describe general features and functionality of a miter saw and are hereby incorporated by reference in their entirety.

In an embodiment, the miter saw 1000 includes a tool housing 1100 in which components, such as, for example, a multi-motor drive unit 1200 (or drive unit) and a transmission 1300 (FIG. 8), are received. A battery pack (not shown) is removably coupled in a battery receptacle 1110 defined by the tool housing 1100, to supply power to the drive unit 1200. The drive unit 1200 and the transmission 1300 output a rotational force in response to power supplied by the battery pack that rotates a blade 1500. In particular, rotary force generated by the drive unit 1200 is transmitted, via the transmission 1300, to a pulley assembly 1600 (FIG. 12) to drive the pulley assembly 1600, which in turn rotates the blade 1500. A handle 1700 provides for user operation of the miter saw 1000. The blade 1500 is partially received in a blade housing 1120 (also referred to as a blade guard or guard). In an embodiment, the blade housing 1120 is semi-circular in shape, to conform to the shape of the blade 1500. The semi-circular shape of the blade housing 1120 leaves a portion of the blade 1500 exposed, for interaction with a workpiece during operation of the miter saw 1000, while functioning as a guard for the hand of the user.

In an embodiment, the miter saw 1000 has a base assembly 1800, including a rotatable table 1900 rotatably connected to the base assembly 1800. The miter saw 1000 has a saw assembly that includes drive unit 1200, transmission 1300, pulley assembly 1600, blade 1500, and a pivot arm 1850 that is pivotally attached to rotatable table 1900 via a pivot junction 1860 and supporting the saw assembly. Pivot arm 1850 is connected to the saw assembly, allowing a user to move the saw assembly downwardly and away from the base assembly 1800 for cutting a workpiece. The pivot arm 1850 may include the handle 1700 and the battery receptacle 1110 such that movement of the pivot arm 1850 through the use of the handle 1700 also moves the battery receptacle 1110 and any attached battery pack. Persons skilled in the art shall recognize that pivot arm 1850 may support one or more sliding rails 1870 connected to the saw assembly, allowing a user to horizontally move the saw assembly towards and away from the front of the base assembly 1800.

The drive unit 1200 and the transmission 1300 are housed within the tool housing 1100 of the miter saw 1000, with the front cover 1290 of the drive unit 1200 and a transmission cover 1390 defining corresponding exterior portions of the tool housing 1100. Preferably, the width of the drive unit 1200 is the same width or less than the width of the blade housing 1120. As seen in FIGS. 8-10, the drive unit 1200 includes a plurality of motors 1210 that are engaged with a master gear 1350 rotating on a stationary shaft 1360. Each of the plurality of motors 1210 may be, for example, a Brushless Direct-Current (BLDC) motor. The motors 1210 may be similar to the motors 200 described in U.S. application Ser. No. 18/647,665, filed Apr. 26, 2024, and titled “Multi-Motor Drive System, which is incorporated herein by reference, and thus duplicative detailed description thereof will be omitted except where necessary. Similarly, the drive unit 1200 may include one or more of the features described above with respect to drive units of the circular saw including a motor adapter, a sleeve, a rear cover, and a front cover, where some of the components are not illustrated in this example, because they are described in U.S. patent application Ser. No. 18/647,665, filed Apr. 26, 2024, and titled “Multi-Motor Drive System”, and U.S. patent application Ser. No. 18/647,689, filed Apr. 26, 2024, and titled “Circular Saw,” both of which are hereby incorporated by reference in their entireties.

In an embodiment, as seen in FIGS. 9-11, the drive unit 1200 includes an arrangement of two motors 1210. In an embodiment, the drive unit 1200 and the motors 1210 are located at the top of the miter saw 1000 in line with the blade 1500 with the axes of rotation of the motors 1210 in parallel with the blade 1500. Further, longitudinal axes through the pinions 1215 of the motors 1210 are parallel to a longitudinal axis through the center of the blade 1500. While this example illustrates two motors 1210, it is understood that the drive unit 1200 may include more than two motors including, three motors, four motors, five motors, six motors, etc.

In an embodiment, the transmission 1300 may be included as part of the drive unit 1200. In an embodiment, the transmission 1300 may be considered separate from the drive unit 1200, but cooperatively engaged with the drive unit 1200. The transmission 1300 includes the master gear 1350 that engages and meshes with the pinions 1215 of the motors 1210. The master gear 1350 rotates around the stationary shaft 1360. The gear reduction from the motors 1210 to the master gear 1350 may be approximately a 60:13 gear reduction.

As seen in FIG. 12, in an embodiment, pulley assembly 1600 may include an input pulley 1610 and multiple output pulleys 1620 coupled together by a belt 1630. The input pulley 1610 preferably engages with the master gear 1350 and transfers rotational motion to the output pulleys 1620 via the belt 1630. In an embodiment, the master gear 1350 may be pressed onto input pulley 1610, which may be a ribbed timing pulley. In an embodiment, the belt 1630 may include a timing belt or a toothed timing belt. The pulley assembly 1600 uses smaller pulleys than a conventional miter saw and thus achieves increased blade speed and cutting performance. With less gear contact, belt noise from the belt 1630 may be reduced compared to a conventional miter saw.

In an embodiment, the compact assembly of the miter saw 1000 based on the location of the drive unit 1200 and the transmission 1300 provides for maximum visibility for the user making cuts on a workpiece with the miter saw 1000. Having the belt 1630 close to the blade housing 1120 enables the stationary shaft 1360 length to be as reduced as possible, thus reducing an overall width of the miter saw 100. This also increases in-cut visibility for the user. As seen in FIGS. 3 and 4, in an embodiment, the center of gravity, CG, for the miter saw 1000 is coplanar with the blade 1500 in a plane B (FIG. 3) and centered about the pivot arm 1850 in a plane C (FIG. 4). Preferably, the plane B will be disposed equidistant between the sliding rails 1870. Preferably, the center of gravity, CG, is about halfway between the center of the blade 1500 and the drive unit 1200. There is a decreased weight realized for the miter saw 1000 compared to a conventional miter saw. Making the center of gravity, CG, coplanar with the blade 1500 avoids torsional moments as well as mitigates some of amount of overall system inertia. In an embodiment, a weight or weights may be added to the drive unit 1200 and/or the motors 1210 to match the inertia between the blade 1500 and the motors 1210 to cancel out the total system inertia during startup and shutdown, which may have the effect of eliminating and/or reducing kick on startup or stop.

As seen in FIG. 5, the location of the battery receptacle 1110 and, thus a battery pack (not shown) when mated with the battery receptacle 1110, is towards the center of the miter saw 1000. In this manner, the weight of the battery receptacle 1110 and any attached battery pack is approximately in-line with the center of gravity CG and the pivot position for the miter saw plunge and any weight effect is mitigated by the location of the battery receptacle 1110. The battery receptacle 1110 is also approximately in-line with the handle 1700 in approximately the same horizontal plane such that during operation, the force applied by the user does not have to counter any offset weight of the battery receptacle 1110 and any attached battery pack because the battery receptacle 1110 is approximately in-line with the handle 1700, where the user grips/grabs to manipulate the blade 1500 towards and away from a workpiece. In this manner, the effects of the battery pack weight may be reduced and/or eliminated on the plunge spring 1880 weight rate. This combined with the above described mitigation on inertia results in a minimum spring rate for a plunge. A low spring rate and reduced or eliminated inertia means that the miter saw 1000 has a smooth start and stop feel for the user and enables the user to feel just the forces that correlate to the cutting action, which results in a more precise and unfiltered cut feedback to the user.

By placing the drive unit 1200 and the transmission 1300 close to the miter saw 1000 centerline, an overall thinner profile of the miter saw 1000 is achieved which mitigates out-of-plane torsion and assists in ensuring a more exact cut on a workpiece. With the pulley assembly 1600 close to the blade housing 1120, the miter saw 1000 width is reduced and in-cut visibility is increased for the user. For example, as seen in FIG. 4, the combined width of the drive unit 1200 and the transmission 1300 is within the profile of the blade housing 1120. That is, the combined width of the drive unit 1200 and the transmission 1300 is less than the width of the blade housing 1120 and fits within the profile width of the blade housing 1120. In one example, the combined width of the drive unit 1200 and the transmission 1300 is approximately 48 mm and the width of the blade housing 1120 is approximately 58 mm. The location of the drive unit 1200 and the transmission 1300 is within the width envelope defined by the blade housing 1120.

FIGS. 6 and 7 illustrate a detailed view of the handle 1700. In this embodiment, the handle 1700 may be an approximately D-shaped handle that includes a grip portion 1710 and a trigger 1720 (or power switch). During operation, a user grips the handle 1700 with a portion of the user's hand wrapping around the grip portion 1710 and another portion of the user's hand wrapping around the trigger 1720 to operate the trigger 1720. When a user pulls the trigger 1720, power is delivered from a battery pack to the drive unit 1200 and rotational motion is imparted to the blade 1500. When a user releases the trigger 1720, power is stopped from being delivered from the battery pack to the drive unit 1200 and rotational motion of the blade 1500 stops.

The handle 1700 may include a motor control module 1730 disposed within the handle 1700. The motor control module 1730 may be used to control the operation of the drive unit 1200 and to control the power delivery from the battery pack to the drive unit 1200 when the trigger 1720 is pulled and released.

The motor control module 1730 in combination with other physical characteristics of the miter saw 1000 enables the miter saw 1000 to achieve improved operational performance. For example, the miter saw 1000 has an overall low system inertia that enables faster blade 1500 start times and faster blade 1500 stop times. In an embodiment, the total system inertia is approximately 7.7e4 kg m². In an embodiment, the blade 1500 is a 7¼ inch blade having an inertia of approximately 7.10e4 kg m². The blade 1500 spin-up time is less than one (1) second at approximately 0.8 seconds. The blade 1500 stop time also may be less than one (1) second. The system inertia less the counter rotational mass is approximately 6.205e4 kg m². The user felt inertia is approximately 84% of the blade 1500 inertia (showing mitigation of the reaction arm torque. As mentioned above, the low system inertia is what enables faster start and stop times, which also means that less energy is applied to moving the system on start and stop. When less energy is used to start and stop the miter saw 1000, then the miter saw 1000 may increase the number of cuts made per battery pack charge.

In an embodiment, the rotors of the motors 1210 rotate in a direction that is opposite the direction of rotation of the blade 1500. In this manner, the opposite spinning directions of the rotors of the motors 1210 and the blade 1500 mitigates the torque on start up of the blade 1500. This also may provide shock absorbing properties in the event of a system stall. In an embodiment, the mass of the rotors of the motors 1210 could be increased by, for example, adding weights to the rotors, to further mitigate the total reaction torque. The operational speed of the blade 1500 may be approximately 6000 RPM and the miter saw power output may be approximately 2200 W.

In an embodiment, the miter saw 1000 may be capable of cutting nominal 2″×6″ sized workpieces with a 7¼ inch blade, with the 6″ dimension of the workpiece in the vertical direction along the fence. Additionally, the miter saw 1000 may be capable of cutting 5.5″ crown molding when the workpiece is place at 45 degrees, with a 7¼ inch blade.

The foregoing description has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “bottom,” “lower,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A miter saw comprising:
a base assembly;
a rotatable table rotatably connected to the base assembly;
a pivot arm pivotally attached to the rotatable table; and
a saw assembly supported by the pivot arm, wherein the saw assembly includes:
a drive unit having a plurality of electric motors,
a transmission coupled to the drive unit through a master gear, and
a blade that is rotatably driven by the drive unit and the transmission.

2. The miter saw of claim 1, wherein the pivot arm includes a handle having a trigger, and the miter saw further comprises:
a motor control module disposed within the handle.

3. The miter saw of claim 1, wherein the pivot arm includes a battery receptacle for receiving a battery pack, and the miter saw further comprises:
a blade housing disposed at least partially around the blade, wherein a profile of the blade housing is aligned within a profile of the drive unit.

4. The miter saw of claim 1, wherein a start of rotation of the blade is less than one second from a time when a user initiates operation of the miter saw.

5. The miter saw of claim 1, wherein a rotation of rotors within the plurality of electric motors is in a direction opposite a rotation of the blade.

6. The miter saw of claim 1, further comprising:
a pulley assembly that couples to and receives rotational force from the transmission and imparts rotational force to the blade; and
a toothed belt disposed around the pulley assembly to impart the rotational force to the blade.

7. The miter saw of claim 1, wherein a center of gravity of the miter saw is coplanar with the blade.

8. The miter saw of claim 7, wherein the pivot arm comprises first and second sliding rails connected to the saw assembly, wherein a plane including the blade is equidistant with the first and second sliding rails.

9. The miter saw of claim 1, wherein a center of gravity of the miter saw is centered about the pivot arm.

10. The miter saw of claim 1, wherein the plurality of electric motors includes a first motor and a second motor, wherein a first motor pinion and a second motor pinion are coupled to the master gear.

11. The miter saw of claim 1, further comprising a blade housing covering the blade, the blade housing having a first width, and the drive unit having a second width, wherein the second width is equal to or smaller than the first width.

12. A miter saw comprising:
a base assembly;
a rotatable table rotatably connected to the base assembly;
a pivot arm pivotally attached to the rotatable table; and
a saw assembly supported by the pivot arm, wherein the saw assembly includes:
a drive unit having a first electric motor and a second electric motor,
a transmission coupled to the drive unit through a master gear, and
a blade that is rotatably driven by the drive unit and the transmission, wherein a center of gravity of the miter saw is coplanar with the blade and centered about the pivot arm.

13. The miter saw of claim 12 wherein the pivot arm includes a handle having a trigger, and the miter saw further comprises:
a motor control module disposed within the handle.

14. The miter saw of claim 12, wherein the pivot arm includes a battery receptacle for receiving a battery pack, and the miter saw further comprises:
a blade housing disposed at least partially around the blade, wherein a profile of the blade housing is aligned within a profile of the drive unit.

15. The miter saw of claim 12, wherein a start of rotation of the blade is less than one second from a time when a user initiates operation of the miter saw.

16. The miter saw of claim 12, wherein a rotation of a first motor rotor and a second motor rotor within the drive unit is in a direction opposite a rotation of the blade.

17. The miter saw of claim 12, further comprising:
a pulley assembly that couples to and receives rotational force from the transmission and imparts rotational force to the blade; and
a toothed belt disposed around the pulley assembly to impart the rotational force to the blade.

18. The miter saw of claim 12, wherein the pivot arm comprises first and second sliding rails connected to the saw assembly, wherein a plane including the blade is equidistant with the first and second sliding rails.

19. The miter saw of claim 12, further comprising a blade housing covering the blade, the blade housing having a first width, and the drive unit having a second width, wherein the second width is equal to or smaller than the first width.
